(19) United States
(12) Patent Application Publication
(10) Pub. No.: US 2010/0006617 A1
(43) Pub. Date: Jan. 14, 2010

(54) METHOD AND AN APPARATUS IN A ROTARY STAPLING MACHINE

(75) Inventor: Per Jacobsson, Vasterhaninge (SE)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(73) Assignee: Tolerans AB, Tyreso (SE)

(21) Appl. No.: 12/525,152

(22) PCT Filed: Jan. 24, 2008
(86) PCT No.: PCT/SE2008/050076

§ 371 Date: Jul. 30, 2009

(30) Foreign Application Priority Data
Jan. 31, 2007 (SE) 0700226-4

(51) Int. Cl. B42B 4/02; B41F 13/66

(52) U.S. Cl. 227/81; 227/156

(57) ABSTRACT

The disclosure relates to a method and an apparatus in a rotary stapling machine (10) which, with a stapling module (12) placed in a stapling cylinder (11), applies staples through a plurality of layers in a material web (16) running through the rotary stapling machine (10), at an interval corresponding to a predetermined cutting length (Δ) along the material web (16), the staples being formed by means of a stapling fork (21) in the stapling module (12) in that wire (23) is advanced to a collection position at a forming wheel (22), the wire (23) being cut off whereafter the stapling fork (21) is urged against the forming wheel (22) in order to form the staple which is thereafter collected by the stapling fork (21) and conveyed for application in the material web (16), as well as final forming against a die (15) in a die cylinder (14), wherein the stapling cylinder (11) rotates two revolutions for each cutting length (Δ).

### TECHNICAL FIELD

The present invention relates to the art of rotary stapling machines intended to staple printed matter, e.g. newspapers and brochures, whose pages appear on double-sided printed running paper web. Each double-sided printed paper web is collected and synchronised to one another, whereafter the collected paper webs are led into the rotary stapling machine. After the stapling operation, the paper web will, on the one hand, be cut and, on the other hand, be folded into individual printed matter of predetermined cutting lengths.

### BACKGROUND ART

From printing presses, one or more paper webs run at constant speed in relation to one another, the paper webs together forming a continuous row of printed matter. The paper webs run past a rotary stapling machine which staples together the paper webs, the paper webs being thereafter cut centrally between the stapling points. In such instance, the printed matter consists of finished publications once folding has been put into effect along the stapling. Moreover, the background to rotary stapling machines is apparent, for instance, from Swedish Patent Specifications 9300536-1 (506 107) and 9300537-9 (506 108) which have their counterpart in U.S. Pat. No. 5,474,221 and U.S. Pat. No. 5,690,266. The rotary stapling machines are mounted in immediate association with the printing presses in spaces specifically adapted for the rotary stapling machines.

The traditional method of stapling printed products direct in the printing press has always been using a so-called double circumference or so-called single circumference rotary stapling machine. The term double circumference or double round stapling machine is taken to signify that its stapling cylinder and its die cylinder are both designed with a circumference corresponding to two product lengths, i.e. cutting lengths, of the printed product, and the term single circumference or single round stapling machine is taken to signify that this circumference corresponds to one product length, i.e. one cutting length. A double-round stapling cylinder rotates half a revolution for each product length, stapling taking place twice per revolution and a single-round stapling cylinder rotates one whole revolution for each product length, stapling taking place once per revolution. Both of these stapling cylinder types display a peripheral speed of the stapling cylinder which corresponds to the speed of the paper web.

The problem inherent in these stapling cylinder types is that they require considerable space, which does not always afford the technical preconditions for installing these rotary stapling machines in certain printing presses.

### OBJECTS OF THE INVENTION

The present invention has for its object to realise a rotary stapling machine and a method in such a machine, the rotary stapling machine requiring such little space that its positioning in a printing press is considerably facilitated in relation to prior art rotary stapling machines.

The present invention further has for its object, by rendering the rotary stapling machines considerably smaller than prior art rotary stapling machines, to make for the installation of a rotary stapling machine in a printing press where this has previously not been technically possible.

### BRIEF OUTLINE OF THE INVENTION

The present invention, as this is apparent in the appended independent Claims, satisfies the above-disclosed objects. Suitable embodiments of the present invention have been disclosed in the appended subclaims.

According to the present invention, a smaller rotary stapling machine may be realised by causing the stapling cylinder of the rotary stapling machine to rotate more than one revolution for each product length and then preferably two revolutions for each product length. When each passing product is to be stapled, the product will thus only be stapled every other time the stapling fork of the stapling cylinder strikes the paper web. This is made possible, for example, by ensuring that stapling wire is only available for collection by the stapling fork every other time the stapling fork passes the wire discharge point.

Thus, according to one embodiment of the present invention, there is required a controlling of the wire feeding in combination with a control of the position of the wire to its collection position with that interval which corresponds to the number of revolutions of the stapling cylinder for stapling.

### BRIEF DESCRIPTION OF THE ACCOMPANYING DRAWINGS

The present invention will now be described in greater detail hereinbelow, with the aid of embodiments and with reference to the accompanying Drawings. In the accompanying Drawings:

FIG. 1 is a schematic perspective view of a rotary stapling machine according to the present invention;

FIG. 2 shows the rotary stapling machine according to FIG. 1 in plan view from the side with one end dismounted;

FIG. 3 is a plan view from the side of the wire handling section of the rotary stapling machine in a collection position;

FIG. 4 is a partial magnification of the collection position according to FIG. 3;

FIG. 5 is a plan view from the side of the wire handling section of the rotary stapling machine in an idling position according to a first embodiment according to the present invention;

FIG. 6 is a partial magnification of the idling position according to FIG. 5;

FIG. 7 is a top plan view of a second embodiment according to the present invention;

FIG. 8 shows the rotary stapling machine according to the present invention in perspective view with a part of a material web;

FIG. 9 shows one alternative embodiment in a collection position; and

FIG. 10 shows the embodiment according to FIG. 9 in an advancement position.

### DESCRIPTION OF THE INVENTION

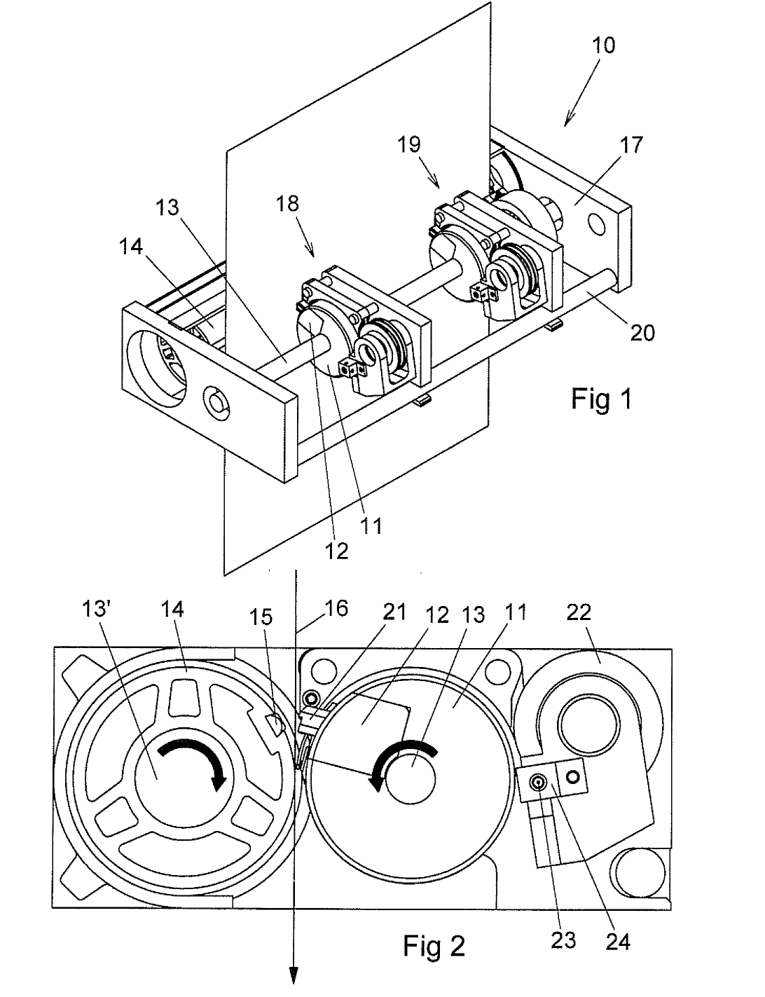

Referring to the Drawings, FIGS. 1 and 2 show a rotary stapling machine 10 provided with a stapling cylinder 11 in which a stapling module 12 is mounted at the periphery of the stapling cylinder. The stapling cylinder is rotatably mounted on a cylinder shaft 13 about which the stapling cylinder is driven by drive means (not shown). The stapling cylinder 11 is further mounted in parallel in relation to a die cylinder 14 acting like a press roller which is rotatable about a corresponding shaft 13′, see FIG. 2, and against which the stapling cylinder rolls. In such instance, the stapling module 12 rolls against a die 15 mounted in the die cylinder 14 for final forming of a staple. Between the stapling cylinder 11 and the press roller 14 runs a material web 16 which consists of a number of paper sheets which are to be stapled together. In such instance, the stapling is intended to take place when the stapling module 12 rolls against the die 15 immediately after the position which is shown in the figure. Both the stapling cylinder 11 and the press roller 14 are rotatably journalled in a machine housing 17. FIG. 1 shows two stapling units 18, 19 which are both mounted on the cylinder shaft as well as on a mounting shaft 20.

FIG. 2 moreover shows that the stapling module 12 is provided with a stapling fork 21 which transports a ready-formed staple from a forming wheel 22 to a position where the staple is forced through the material web 16 and finally formed against the die 15. The figure also shows the directions of rotation of the stapling cylinder 11 and the die cylinder 14 as well as the direction of movement of the material web 16. Both the stapling cylinder 11 and the die cylinder 14 rotate at constant speed which corresponds to a peripheral speed which is equal to the speed of the material web 16.

The forming of each staple is put into effect in that wire 23 from a wire magazine reel (not shown) is advanced through a wire guide module 24 to a cutting position whereafter cutting, forming and collection of the staple take place when the stapling fork 21 passes the forming wheel 22. Conventionally, these operational phases have been carried out during each individual stapling cylinder revolution when the stapling module, with its stapling fork, has passed the forming wheel 22. However, according to the present invention the stapling fork 21 passes the forming wheel 22 every other time without collection of the staple taking place, which implies that stapling through the material web 16 takes place only every other time the stapling fork 21 rolls against the die cylinder 14 with its die 15.

In order realise that the stapling fork only collects one staple every other stapling cylinder revolution, a collection position is defined, this position being intended only to contain wire or alternatively a staple when a stapling fork passes the collection position in a position for the stapling fork that collection can take place. In such instance, the following embodiments are conceivable:

1. The stapling fork passes the collection position in a position for the stapling fork which entails that collection can be put into effect every time the stapling fork passes the collection position, but that an axial advancement of the wire to the collection position is made only every other stapling cylinder revolution.
2. The stapling fork passes the collection position in a position for the stapling fork which entails that collection can take place every time the stapling fork passes the collection position, but that a lateral displacement of the wire from an advancement position to the collection position is made only every other stapling cylinder revolution.
3. An axial advancement of the wire to the collection position is made every stapling cylinder revolution, but the stapling fork is guided radially or by angling so as to be displaced out to the collection position only every other stapling cylinder revolution.
4. An axial advancement of the wire to the collection position is made every stapling cylinder revolution, but the stapling fork is guided radially or by angling so as to be displaced away from the collection position every other stapling cylinder revolution.

This displacement of either the wire or the stapling fork may be put into effect in a plurality of ways, e.g. by means of a controlled pneumatic cylinder by a controlled wire feeding device, or with the aid of an eccentric device.

In all of these conceivable embodiments, a wire feeding feature is necessary, but this may either be constant or intermittent.

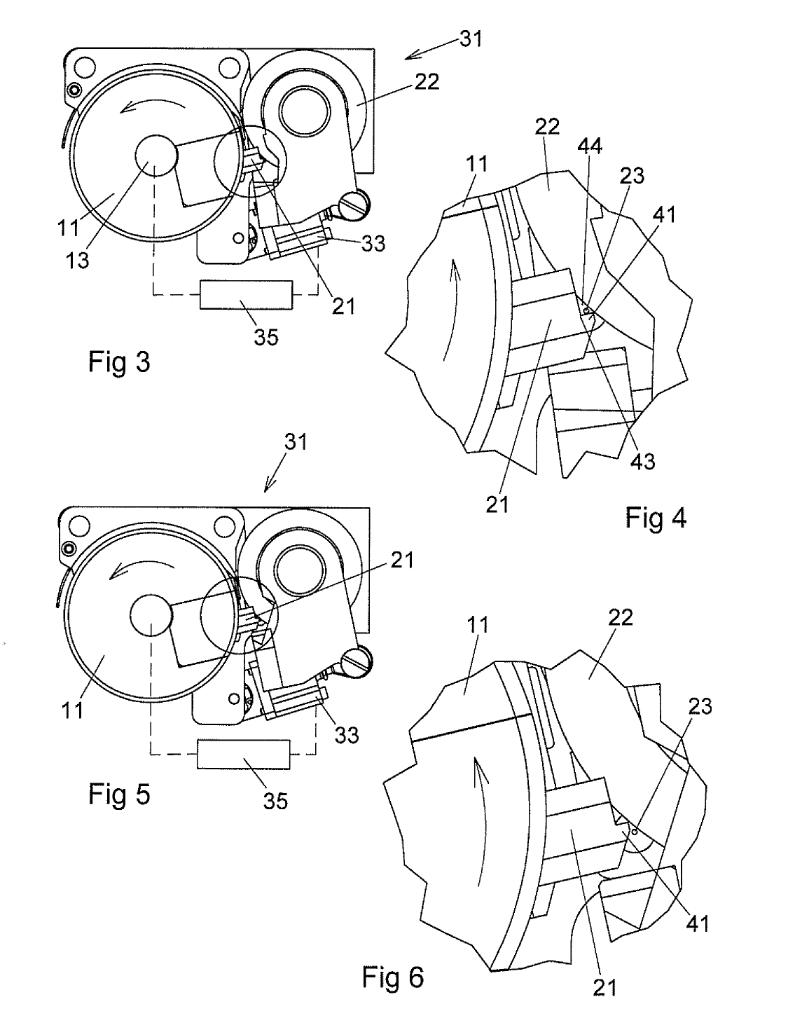

FIGS. 3-6 describe one embodiment with constant wire feeding, but with displacement of the collection position.

FIG. 3 shows a wire handling section 31 in the rotary stapling machine in a collection position for the wire where the stapling cylinder 3 with its stapling fork 21 rotates in the direction of the arrow and is just about to pass the forming wheel 22. The wire handling section 31 is provided with a pneumatic cylinder 33 which is disposed to operate the position of the wire between an advancement position and the collection position. Guide means 35 is connected to the cylinder and is directly dependent upon the speed of the stapling cylinder, which is indicated by the broken line between the guide means and the cylinder shaft 13 so that operation by the cylinder of the wire position from passive advancement position to active collection position takes place every other stapling cylinder revolution.

FIG. 4 shows a magnification of the cooperation region between the stapling cylinder 11 and the forming wheel 22, this region being encircled in FIG. 3. The stapling fork 21 is, with its jaw 41, in the process of grasping the wire 23 which is placed in the collection position. When the wire 23, on continued rotation of the stapling cylinder 11, marked with the arrow, the wire will slide down into the abutment corners 43 of the stapling fork 21 and be moved towards a scissors device 44 in order to be cut off to a straight wire length which directly in the next stage is pressed against the forming wheel 22 and bent to a [symbol] -shaped staple which, by the stapling fork 21, is transported to the position illustrated in FIG. 2 whereafter, on continued rotation of the stapling cylinder 11, the shanks of the staple are pressed through the material web, the shanks being bent against the die 15, see FIG. 2.

FIG. 5 shows the wire handling section 31 in the rotary stapling machine in an advancement position for the wire one stapling cylinder revolution later than that shown in FIG. 3. The stapling cylinder 11, with its stapling fork 21, still rotates in the direction of the arrow and is just about to pass the forming wheel 22. However, the guide means 35 has received information from a revolution indicator, which has been indicated by the broken line, that one stapling cylinder revolution has passed since active collection position, in which event the pneumatic cylinder 33 has set the wire in passive advancement position. In actual fact, this switching between active and passive position takes place immediately once the stapling fork 21 has passed the encircled cooperation region.

FIG. 6 shows a corresponding magnification of the cooperation region between the stapling cylinder 11 and the forming wheel 22 as in FIG. 4. In this instance, the jaw 41 of the stapling fork 21 passes the collection position without there being any wire to collect, since the pneumatic cylinder has displaced the wire 23 laterally to its advancement position. Thus, the stapling fork will neither grasp the wire, cut the wire into a wire length nor form the wire length into a [symbol] -shaped staple during this stapling cylinder revolution. Nor will any staple be pressed through the material web half a revolution later.

In that the wire is moved alternatingly between an active collection position and a passive advancement position, the wire can be fed constantly at a speed of one requisite staple length for two stapling cylinder revolutions.

The wire is constantly fed axially in the embodiment illustrated in FIGS. 3-6 via a feeder housing to its advancement position which is illustrated in FIG. 6, the pneumatic cylinder being activated so that the advancement position is laterally displaced to the collection position. In that the activation of the cylinder at the correct position on the stapling cylinder revolution is controlled with the aid of an indicator and a solenoid valve, the risk is eliminated that the cutting device will cut a wire which is advanced halfway at the collection position as illustrated in FIG. 4. As was previously described, the operation by the cylinder of the wire position from passive advancement position to active collection position takes place every other stapling cylinder revolution.

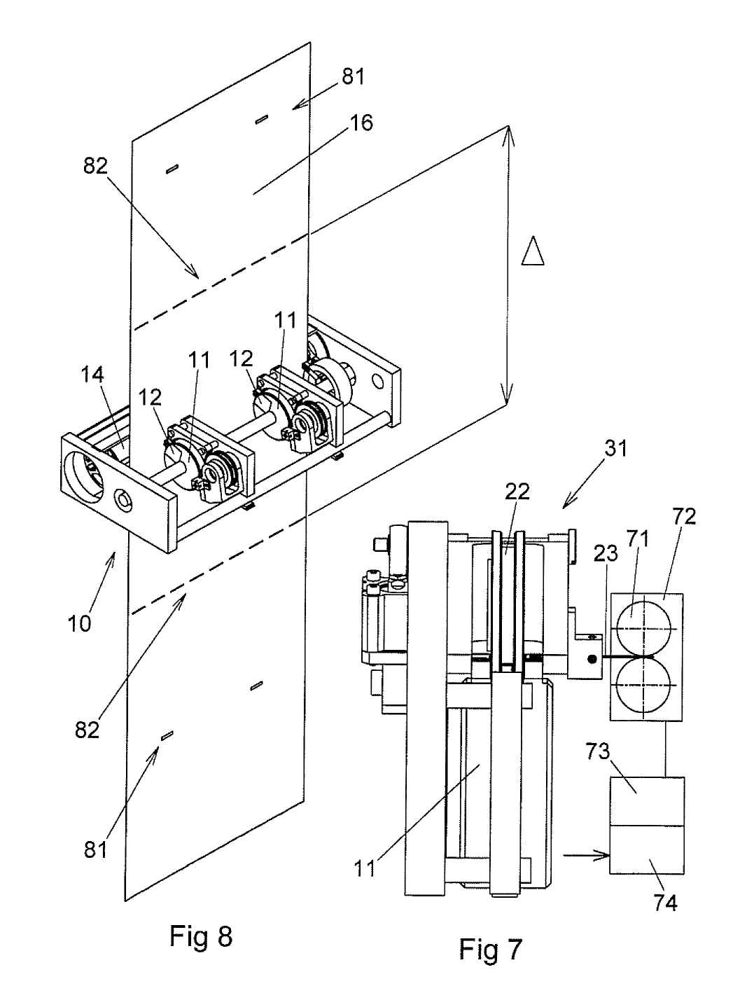

FIG. 7 shows a second embodiment of the present invention, the wire handling section 31 being shown from above with its stapling cylinder 11 and forming wheel 22. In such instance, wire 23 is advanced intermittently from a wire magazine reel (not shown) by the feeder wheel 71 located in a feeder housing 72. The intermittent feeding of the wire 23 is realised in that the feeder wheel 71 is driven by an electrically controlled step motor 73 so that the advancement takes place directly to the collection position whereafter grasping of the wire, cutting of the wire into a wire length, as well as forming of the wire length into a [symbol] -shaped staple and collection take place in the same manner as previously described. The controlling of the step motor 73 takes place by means of a motor control unit 74 connected to the motor which receives signals direct from the stapling cylinder 11, which is indicated by means of the arrow in FIG. 7, as regards speed of revolution and whether the current revolution is an “odd” revolution or an “even” revolution in order for the motor 73 of the feeder housing 72 to advance the requisite length of staple wire 23 after that revolution when the stapling fork has passed the collection position without collecting a staple, i.e. after that revolution during which the rotary stapling machine is not to carry out any stapling.

According to one alternative embodiment of this intermittent feeding, the feeder wheel is instead driven by a transmission (not shown) from the stapling cylinder 11. Correspondingly, the transmission is disposed to advance, with the feeder wheel 71, staple wire for collection by the stapling fork every other revolution.

FIG. 8 shows the rotary stapling machine 10 according to the present invention with the continuous material web 16. In such instance, the stapling positions 81 of the material web as well as their cutting positions 82 have been marked, these positions in the material web showing the proportion between the size of the rotary stapling machine 10 in relation to the marked cutting length Δ. It should be observed that neither stapling nor cutting can be put into effect before the material web has passed the stapling cylinder 11, but the positions in the material web 16 above the rotary stapling machine 10 have merely been marked in the figure so as to illustrate the proportions. The cutting length represents the size of a centrefold open final product. In the position which the figure illustrates, the stapling forks 12 of the stapling cylinders 11 are just about to press their staple through the material web 16, the staples being bent against the die of the die cylinder 14, the actual stapling positions 81 of the staples being shown below the rotary stapling machine.

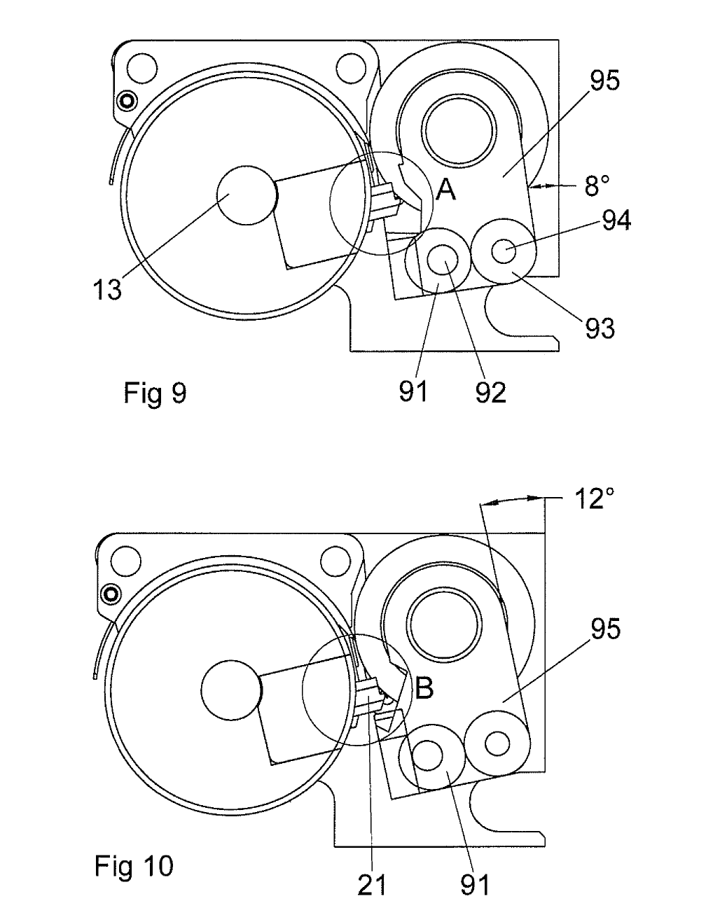

FIGS. 9 and 10 show one alternative embodiment to the embodiment which was described with reference to FIGS. 3-6. In order to show the stapling fork and the wire, other parts have been cut away from the figures. The wire feeding still takes place constantly, but the pneumatic cylinder has been replaced by a mechanically driven excenter 91 which is rotary about an eccentric shaft 92 in order to displace the wire from its advancement position, illustrated in FIG. 10, to its collecting position, illustrated in FIG. 9, every other stapling cylinder revolution in that the excenter 91 displaces an eccentric roller 93 which is rotatably mounted about a pressure shaft 94. The pressure shaft 94 is fixedly mounted on a bracket 95 for the wire feeding, the bracket having been permitted an angular movement of 4°, in the figures shown as a change of angle from 8° to 12°. This excenter 91 is driven preferably by the stapling cylinder shaft 13 at a speed n which corresponds to half of the speed of the speed of the stapling cylinder shaft N rpm, i.e. n=N*0.5 rpm.

FIG. 10 shows the position of the bracket 95 when this has been displaced by the excenter 91 so that the stapling fork 21 is free from the wire. The position which is shown in FIG. 9 of the encircled region A is identical with that shown in FIG. 4 and the position which is shown in FIG. 10 of the encircled region B is identical to that shown in FIG. 6.

1. A method in a rotary stapling machine which, with a stapling module placed in a stapling cylinder, applies staples through a plurality of layers in a material web running through the rotary stapling machine at an interval corresponding to a predetermined cutting length along the material web (16), the staples being formed by a stapling fork in the stapling module in that wire is advanced to a collection position at a forming wheel, the wire being cut off, whereafter the stapling fork is urged against the forming wheel in order to form the staple which is thereafter collected by the stapling fork and conveyed for application in the material web as well as final forming against a die in a die cylinder, wherein the stapling cylinder rotates two revolutions for each cutting length.

2. The method as claimed in claim 1, wherein the stapling fork is deactivated from the collection position of staples every other stapling cylinder revolution.

3. The method as claimed in claim 2, wherein an eccentric device mounted in the stapling cylinder activates and deactivates, respectively, the stapling fork from the collection position every other stapling revolution.

4. The method as claimed in claim 1, wherein the wire is made available in the collection position of the stapling fork only every other stapling cylinder revolution.

5. The method as claimed in claim 1, wherein the wire is advanced intermittently to the collection position only every other stapling cylinder revolution by a controlled motor which starts and stops the wire advancement.

6. The method as claimed in claim 1, wherein the wire is displaced laterally to the collection position only every other stapling cylinder revolution by an eccentric axially controlled wire feeding movement.

7. The method as claimed in claim 1, wherein the wire is displaced laterally to the collection position by a varied movement controlled by means of a pneumatic cylinder.

8. A rotary stapling machine provided with a stapling module placed and driven about a shaft in a stapling cylinder, by means of a stapling fork to apply staples to a material web at predetermined positions along the material web, where the distance between said positions corresponds to a predetermined cutting length, wherein the circumference of the stapling cylinder is equal to half of the cutting length.

9. The rotary stapling machine as claimed in claim 8, wherein the peripheral speed of the stapling cylinder is equal to the speed of the material web.

10. The rotary stapling machine as claimed in claim 8, wherein the stapling form is disposed, from a collection position, to collect a staple only every other stapling cylinder revolution.

11. The rotary stapling machine as claimed in claim 8, wherein an eccentric device is mounted about the cylinder shaft in the stapling cylinder against which eccentric device the stapling form abuts, the eccentric device being designed to displace, every other revolution, the stapling fork out to a collection position, and every other revolution therebetween to remove the stapling form from the collection position.

12. The rotary stapling machine as claimed in claim 8, wherein a wire feeding unit and a wire forming unit are disposed to cooperate with a wire collection unit, the three units being mounted in association with the periphery of the stapling cylinder.

13. The rotary stapling machine as claimed in claim 12, wherein a wire positioning device is mounted in association with the stapling cylinder, the wire positioning device being disposed, intermittently every other stapling cylinder revolution, to place the wire in a collection position for the wire collection unit.

14. The rotary stapling machine as claimed in claim 13, wherein the wire positioning device consists of control unit connected to the rotary stapling machine and disposed to axially displace the wire to its collection position only every other stapling cylinder revolution.

15. The rotary stapling machine as claimed in claim 13, wherein the wire positioning device consists of an excenter disposed to displace the wire laterally to its collection position.

16. The rotary stapling machine as claimed in claim 13, wherein the wire positioning device consists of a pneumatic cylinder disposed to displace the wire laterally to its collection position.
